(19) United States
(12) Patent Application Publication
(10) Pub. No.: US 2015/0199484 A1
(43) Pub. Date: Jul. 16, 2015

(54) USING SENSORS AND DEMOGRAPHIC DATA TO AUTOMATICALLY ADJUST MEDICATION DOSES

(71) Applicant: Microsoft Corporation, Redmond, WA (US)

(72) Inventors: Daniel Scott Morris, Bellevue, WA (US); Desney S. Tan, Kirkland, WA (US); Timothy Scott Saponas, Woodinville, WA (US); Paul Henry Dietz, Redmond, WA (US); Andrew David Wilson, Seattle, WA (US)

(21) Appl. No.: 14/499,628

(22) Filed: Sep. 29, 2014

Related U.S. Application Data
(60) Provisional application No. 61/927,680, filed on Jan. 15, 2014.

(51) Int. Cl. G06F 19/00

(52) U.S. Cl. CPC G06F 19/345; G06F 19/3456

(57) ABSTRACT

Various technologies described herein pertain to adjust recommended dosages of a medication for a user in a non-clinical environment. The medication can be identified and an indication of a symptom of the user desirably managed by the medication can be received. An initial recommended dosage of the medication can be determined based on static data of the user and the symptom. Dynamic data indicative of efficacy of the medication for the user over time in the non-clinical environment can be collected from sensor(s) in the non-clinical environment. The dynamic data indicative of the efficacy of the medication can include data indicative of the symptom and data indicative of a side effect of the user resulting from the medication. A subsequent recommended dosage of the medication can be refined based on the static data of the user and the dynamic data indicative of the efficacy of the medication for the user.

### CROSS-REFERENCE TO RELATED APPLICATION

This application claims priority to U.S. Provisional Patent Application No. 61/927,680, filed on Jan. 15, 2014, and entitled “USING SENSORS AND DEMOGRAPHIC DATA TO AUTOMATICALLY ADJUST MEDICATION DOSES”, the entirety of which is incorporated herein by reference.

### BACKGROUND

In clinical environments, a recommended dosage of a medication is commonly personalized for a patient based on the patient's weight and gender. The recommended dosage may thereafter be adjusted based on effectiveness (e.g., persistence of symptoms) and side effects resulting from such medication. Personalization and adjustment are common for both in-patient treatment (e.g., where the patient is observed regularly to assess symptoms and side effects) and out-patient treatment (e.g., where the patient returns to the clinic periodically to have the recommended dosage adjusted).

However, many common scenarios do not lend themselves to personalization and adjustment of a recommended dosage of a medication over time. For example, over-the-counter (OTC) medications, which make up more than half of medications administered in the United States, are commonly dosed in an open loop. OTC medications oftentimes have broad dosage classes that are provided by medication labels. According to an illustration, a medication label can recommend the same dose of a medication for both a six-year-old child and a 300 pound adult. Moreover, no adjustment mechanism for a recommended dosage is typically used for OTC medications beyond taking the medication while symptoms persist. Pursuant to another example, many non-OTC medications, such as those prescribed for acute conditions (e.g., infections), oftentimes are prescribed by a doctor that manages one-time personalized dosing. Feedback mechanisms are typically not utilized for non-OTC medications in such scenarios. Thus, recommended dosages of these non-OTC medications are not adjusted based on symptoms or side effects other than in extreme cases that lead to a return to the clinic by the patient.

Accordingly, conventional approaches oftentimes result in a lack of precision in suggesting dosages of a medication for a patient. Thus, smaller individuals can receive more medication than is necessary to relieve symptoms, while larger individuals may not receive the full benefit of the medication.

### SUMMARY

Described herein are various technologies that pertain to using sensors and demographic data of a user to personalize and automatically adjust recommended dosages of a medication in a non-clinical environment. The medication can be identified, where the recommended dosages of the medication can be desirably personalized for the user. Moreover, an indication of a symptom of the user desirably managed by the medication can be received. Further, an initial recommended dosage of the medication can be determined based at least on static data of the user and the symptom of the user desirably managed by the medication. Dynamic data indicative of efficacy of the medication for the user over time in the non-clinical environment can further be collected from one or more sensors in the non-clinical environment. The dynamic data indicative of the efficacy of the medication for the user over time in the non-clinical environment can include data indicative of the symptom of the user desirably managed by the medication and data indicative of a side effect of the user resulting from the medication. A subsequent recommended dosage of the medication can be refined based on the static data of the user and the dynamic data indicative of the efficacy of the medication for the user over time in the non-clinical environment.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that uses sensors and demographic data of a user to automatically adjust recommended dosages of a medication for the user in a non-clinical environment.

FIG. 2 illustrates a functional block diagram of an exemplary system that uses sensor(s) of a computing system and/or external sensor(s) as well as demographic data of the user to automatically adjust recommended dosages of a medication in the non-clinical environment.

FIG. 3 illustrates a functional block diagram of an exemplary system that adjusts recommended dosages of the medication for the user in the non-clinical environment.

FIG. 4 illustrates a functional block diagram of an exemplary system that employs a display device in the non-clinical environment to display recommended dosages of the medication for the user.

FIG. 5 illustrates an isometric view of an exemplary display device according to various embodiments.

FIG. 6 illustrates an isometric view of another exemplary display device according to various embodiments.

FIG. 7 is a flow diagram that illustrates an exemplary methodology of adjusting recommended dosages of a medication.

FIG. 8 is a flow diagram that illustrates another exemplary methodology of adjusting recommended dosages of a medication.

FIG. 9 is a flow diagram that illustrates another exemplary methodology of adjusting recommended dosages of a medication.

FIG. 10 illustrates an exemplary computing device.

FIG. 11 illustrates an exemplary computing system.

### DETAILED DESCRIPTION

Various technologies pertaining to using sensors and demographic data of a user to personalize and automatically adjust a recommended dosage of a medication in a non-clinical environment are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

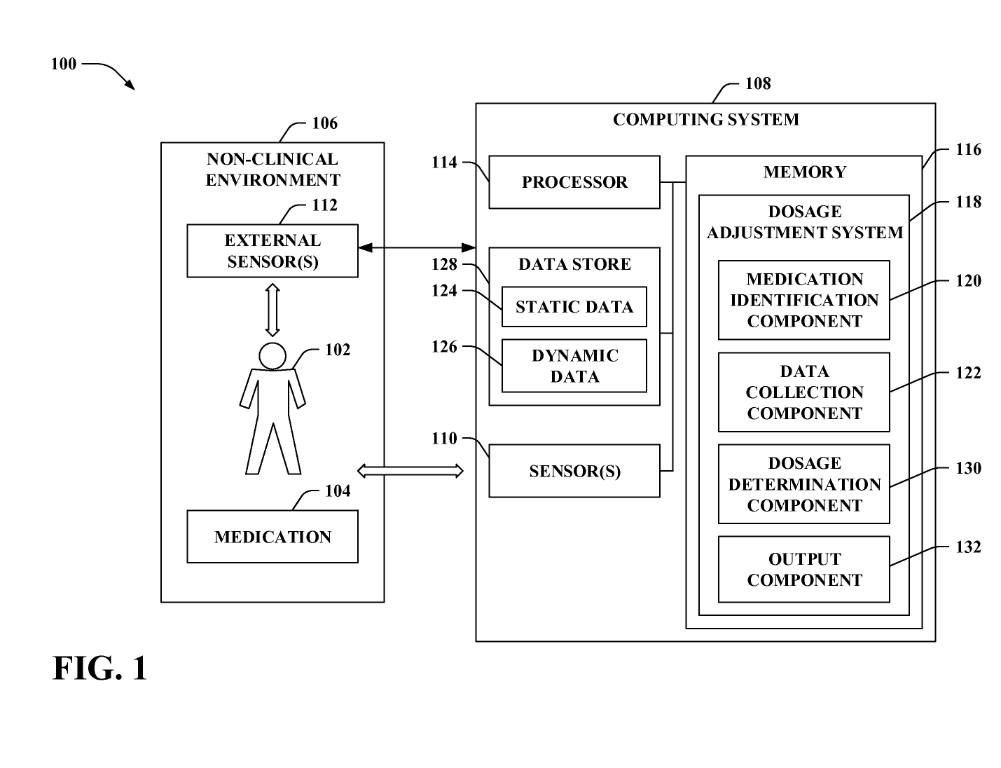

Referring now to the drawings, FIG. 1 illustrates a system 100 that uses sensors and demographic data of a user 102 to automatically adjust recommended dosages of a medication 104 for the user 102 in a non-clinical environment 106. The system 100 further includes a computing system 108. According to various examples, the computing system 108 can be within proximity of the user 102 in the non-clinical environment 106. Pursuant to such examples, the computing system 108 can directly collect data indicative of efficacy of the medication 104 for the user 102 over time in the non-clinical environment 106 (e.g., data can be directly collected by sensor(s) 110 of the computing system 108). Yet, according to other examples, the computing system 108 need not be within proximity of the user 102; for instance, data can be collected by external sensor(s) 112 within proximity of the user 102 in the non-clinical environment 106, and such data can be transmitted to the computing system 108.

The computing system 108 includes a processor 114 and a memory 116. The processor 114 is configured to execute instructions loaded into the memory 116 (e.g., one or more systems loaded into the memory 116 are executable by the processor 114, one or more components loaded into the memory 116 are executable by the processor 114, etc.). As described in greater detail herein, the memory 116 includes a dosage adjustment system 118 that automatically adjusts recommended dosages of the medication 104 for the user 102. Thus, the dosage adjustment system 118 is executable by the processor 114.

According to various examples, the computing system 108 can be or include a computing device. Pursuant to various illustrations, the computing system 108 can be a desktop computing device, a gaming console, a set-top box, an in-vehicle communications and infotainment system, or the like. According to other illustrations, the computing system 108 can be a mobile consumer computing device; examples of mobile consumer computing devices include a laptop computing device, a mobile telephone (e.g., smartphone), a tablet computing device, a wearable computing device, a handheld computing device, a portable gaming device, a personal digital assistance, or the like. According to another example, the mobile consumer computing device can be a display device as described in greater detail herein.

In accordance with other examples, the computing system 108 can be or include one or more server computing devices. For instance, the computing system 108 can be or include one or more datacenters, where a datacenter includes a plurality of server computing devices. Additionally or alternatively, the computing system 108 can be a distributed computing system.

The dosage adjustment system 118 can collect (e.g., via the sensor(s) 110 and/or the external sensor(s) 112) various data indicative of efficacy of the medication 104 for the user 102 over time in the non-clinical environment 106. Moreover, the dosage adjustment system 118 can adjust recommended dosages of the medication 104 based at least in part upon the data indicative of the efficacy of the medication 104. The recommended dosages of the medication 104 can further be presented to the user 102 (e.g., directly by the dosage adjustment system 118 via a display screen of the computing system 108, the dosage adjustment system 118 can cause a disparate device separate from the computing system 108 to present the recommended dosages of the medication 104 to the user 102, etc.). A recommended dosage of the medication 104 can specify, for example, an amount of the medication 104 for a dose, a time for administering the dose of the medication 104, a rate of administering the dose of the medication 104, a number of remaining doses of the medication 104, a frequency of administering doses of the medication 104, and so forth.

The dosage adjustment system 118 can cause personalized dosage information to be presented to the user 102 without complicating medication labels or increasing cognitive burden on the user 102. The dosage adjustment system 118 can collect relevant feedback concerning common symptoms and side effects using ubiquitous automatic sensors. The feedback can be collected utilizing the sensor(s) 110 of the computing system 108 and/or the external sensor(s) 112 (e.g., sensor(s) that are external to the computing system 108, sensors that can collect feedback and communicate such feedback to the computing system 108, etc.). Further, the dosage adjustment system 118 can deliver the adjusted dosage information based on the feedback collected from the sensor(s) 110 and/or the external sensor(s) 112.

It is to be appreciated that in clinical environments, medication dosage is commonly personalized based on weight and gender of a patient. In such environments, the dosage is oftentimes adjusted based on effectiveness and side effects resulting from the medication. Clinical environments include doctor's offices, medical clinics, medical centers, hospitals, emergency rooms, and so forth. In contrast, medication dosage is typically not personalized and adjusted outside of such clinical environments. Accordingly, the dosage adjustment system 118 can personalize and adjust recommended dosages of the medication 104 in the non-clinical environment 106 (e.g., environments other than clinical environments).

In accordance with various embodiments, the medication 104 can be an over-the-counter (OTC) medication. An OTC medication is a medication that does not require a doctor's prescription. Examples of OTC medications include acetaminophen, non-steroidal, anti-inflammatory drugs (NSAIDs) (e.g., ibuprofen, naproxen, etc.), cough medications (e.g., guaifenesin, liquid cough suppressants with dextromethorphan, etc.), oral decongestants (e.g., pseudoephedrine, phenylephrine, etc.), decongestant nasal sprays (e.g., oxymetazoline, phenylephrine, etc.), sprays for numbing throat pain (e.g., dyclonine, phenol, etc.), antihistamines (e.g., diphenhydramine, chlorpheniramine, brompheniramine, clemastine, loratadine, fexofenadine, cetirizine, etc.), antidiarrheal medications (e.g., loperamide, etc.), medications to manage nausea and vomiting, medications to manage motion sickness (e.g., dimenhydrinate, meclizine, etc.), and medications to manage skin rashes and itching (e.g., hydrocortisone cream, etc.). However, it is to be appreciated that substantially any other OTC medication is intended to fall within the scope of the hereto appended claims. Moreover, according to yet other embodiments, the medication 104 can be a non-OTC medication. Thus, while many of the examples set forth herein pertain to the medication 104 being an OTC medication, it is to be appreciated that such examples can be extended to scenarios where the medication 104 is a non-OTC medication.

The dosage adjustment system 118 can include a medication identification component 120 that identifies the medication 104 (e.g., if the medication 104 is an OTC medication, then the medication identification component 120 can identify the OTC medication). Recommended dosages of the medication 104 can desirably be personalized by the dosage adjustment system 118 for the user 102. In order to personalize the recommended dosages of the medication 104, the dosage adjustment system 118 is informed about the medication 104 that the user 102 is taking (e.g., by the medication identification component 120 identifying the medication 104).

By way of example, the medication identification component 120 can receive user input that specifies the medication 104 (e.g., the medication 104 administered or to be administered to the user 102 is manually entered by the user 102 and/or a disparate user). According to another example, the medication identification component 120 can utilize one or more of the sensor(s) 110 or the external sensor(s) 112 to detect the medication 104. By way of illustration, the medication identification component 120 can utilize a camera (e.g., the sensor(s) 110 and/or the external sensor(s) 112 can include such camera), which can capture an image of a label of the medication 104. Following this illustration, the medication identification component 120 can compare the image of the label against a database of known images to identify the medication 104. For instance, the camera can capture an image of a Quick Response (QR) code on a medication container of the medication 104, and the identity of the medication 104 can be detected by the medication identification component 120 based upon the image of the QR code. Yet, it is contemplated that an image of substantially any other marking, logo, text, barcode, or the like on the medication container can similarly be evaluated by the medication identification component 120 to identify the medication 104. Pursuant to another illustration, the medication identification component 120 can utilize a radio frequency identification (RFID) reader to detect a non-visual indicator (e.g., RFID tag) included in or affixed to the medication container of the medication 104 (e.g., the sensor(s) 110 and/or the external sensor(s) 112 can include the RFID reader). Accordingly, the medication identification component 120 can identify the medication 104 based upon the RFID tag corresponding to the medication 104 detected by the RFID reader.

Although not depicted in FIG. 1, it is contemplated that the medication 104 can be identified by a disparate device (e.g. a display device as set forth herein) in various embodiments. Thus, in such embodiments, the disparate device can send data that specifies the identity of the medication 104 to the computing system 108, and the medication identification component 120 can identify the medication 104 based upon the data received from the disparate device.

The dosage adjustment system 118 further includes a data collection component 122. In order to personalize and adjust recommended dosages of the medication 104, the data collection component 122 can collect static data 124 of the user 102 and dynamic data 126 indicative of efficacy of the medication 104 for the user 102 over time in the non-clinical environment 106. The computing system 108 can include a data store 128, and the data collection component 122 can retain the static data 124 of the user 102 and the dynamic data 126 indicative of the efficacy of the medication 104 for the user 102 in the data store 128. The data collection component 122 can further retain historical dosage information (e.g., previous recommended dosages, actual administered dosages, etc.) for the user 102 in the data store 128. Moreover, the data collection component 122 can retain data pertaining to other medications that the user 102 is current taking or has previously taken in the data store 128 (e.g., to generate warnings regarding combinations of medications to avoid, etc.).

More particularly, the data collection component 122 can receive an indication of a symptom of the user 102 desirably managed by the medication 104. For instance, the data collection component 122 can receive user input that specifies the symptom from the user 102. According to another example, the symptom can be detected by the data collection component 122 utilizing data collected by the sensor(s) 110 of the computing system 108 and/or the external sensor(s) 112. By way of yet another example, the symptom can be determined based upon the identity of the medication 104 as detected by the medication identification component 120.

Moreover, the data collection component 122 can collect the static data 124 of the user 102. The static data 124 of the user 102 (e.g., demographic data of the user 102) can include information about the user 102 such as weight, height, age, gender, other demographic information, and so forth. Further, the static data 124 of the user 102 can include information indicative of a known allergy of the user 102, a known response of the user 102 to a differing medication in a class that includes the medication 104, previous medical history of the user 102, or previous emotional state history of the user 102 for medications that have possible psychoactive side effects.

The data collection component 122 can retrieve the static data 124 of the user 102 from substantially any source. For example, the computing system 108 can be connected to a personal health record service, a social network service, or other source of demographic information from which the data collection component 122 can receive the static data 124 of the user 102. Additionally or alternatively, the data collection component 122 can receive user input that specifies the static data 124 of the user 102. Further, the data collection component 122 can retain the static data 124 of the user 102 in the data store 128.

The data collection component 122 can also collect, from at least one of the sensor(s) 110 and/or the external sensor(s) 112 in the non-clinical environment 106, the dynamic data 126 indicative of the efficacy of the medication 104 for the user 102 over time in the non-clinical environment 106. The data collection component 122 can further retain the dynamic data 126 indicative of the efficacy of the medication 104 for the user 102 in the data store 128. The dynamic data 126 indicative of the efficacy of the medication 104 for the user 102 over time in the non-clinical environment 106 can include data indicative of the symptom of the user 102 desirably managed by the medication 104 and data indicative of a side effect of the user 102 resulting from the medication 104. Thus, the data collection component 122 can obtain dynamic feedback about the effectiveness of the medication 104 for the user 102 over time. It is contemplated that the data collection component 122 can track various metrics from information collected by the sensor(s) 110 included in the computing system 108 and/or the external sensor(s) 112 prior to administering the medication 104 to the user 102 (e.g., to obtain baseline values) and/or for at least a period of time after the medication 104 is administered to the user 102.

According to various embodiments, the user 102 can be continuously monitored in the non-clinical environment 106 utilizing the sensor(s) 110 and/or the external sensor(s) 112 (e.g., the user 102 can wear wearable sensor(s), carry the computing system 108, etc.). Thus, the data collection component 122 can continuously collect the dynamic data 126 indicative of the efficacy of the medication 104 for the user 102 over time.

Moreover, the dosage adjustment system 118 includes a dosage determination component 130 that can determine recommended dosages of the medication 104 personalized for the user 102. More particularly, the dosage determination component 130 can determine an initial recommended dosage of the medication 104 based at least on the static data 124 of the user 102 and the symptom of the user 102 desirably managed by the medication 104. Further, the dosage determination component 130 can refine a subsequent recommended dosage of the medication 104 based on the static data 124 of the user 102 and the dynamic data 126 indicative of the efficacy of the medication 104 for the user 102 over time in the non-clinical environment 106. The dosage determination component 130 can use the static data 124 and the dynamic data 126 for the user 102, as well as knowledge of the medication 104 from a database of medical background and/or data pertaining to efficacy of the medication 104 for other users, to adjust the recommended dosage for subsequent administrations of the medication 104 subject to constraints. For example, based on the demographic information of the user 102 (e.g., the user 102 is a female who weighs 125 pounds) and audio data collected from a microphone (e.g., the sensor(s) 110 and/or the external sensor(s) 112 can include the microphone) by the data collection component 122 since a first dose of the medication 104 was administered (e.g., the data collection component 122 can track a number of coughs of the user 102 since administration of the first dose of the medication 104), the dosage determination component 130 can determine a minimum dose required for maintaining cough suppression for a next four hours. However, it is to be appreciated that the claimed subject matter is not limited to the foregoing example.

The dosage adjustment system 118 can further include an output component 132 that outputs information indicative of the recommended dosages determined by the dosage determination component 130. Although not shown, it is contemplated that the computing system 108 can further include a display screen; accordingly, the output component 132 can cause the initial recommended dosage of the medication 104 as well as subsequent recommended dosage(s) of the medication 104 to be displayed on the display screen of the computing system 108. According to another example, the output component 132 can send information indicative of the initial recommended dosage of the medication 104 and the subsequent recommended dosage(s) of the medication 104 to a disparate device (e.g., the display device, a differing mobile consumer computing device positioned within proximity of the user 102 in the non-clinical environment 106, etc.) for display upon a display screen of such disparate device. Thus, the output component 132 can cause the refined dosage information to be presented back to the user 102 on the display screen of the computing system 108 and/or the display screen of the disparate device.

According to another example, the output component 132 can provide substantially any other output pertaining to the recommended dosages of the medication 104. For instance, the output component 132 can provide audible output (e.g., via a speaker of the computing system 108 or the disparate device). By way of yet another example, the computing system 108 (or the disparate device) can dispense the medication 104 (e.g., the computing system 108 or the disparate device can be a medication container that dispenses the medication 104, the computing system 108 or the disparate device can remove the medication 104 from a medication container for dispensing to the user 102, etc.). Following this example, the output component 132 can cause the recommended dosages of the medication 104 to be dispensed to the user 102.

Pursuant to other embodiments, the medication identification component 120 can identify a plurality of medications available for the user 102 in the non-clinical environment 106. For instance, the medication identification component 120 can identify medications in a medicine cabinet of the user 102. Thus, upon the data collection component 122 receiving the indication of the symptom of the user 102 desirably managed by a medication, the dosage determination component 130 can identify one or more of the available medications identified by the medication identification component 120 to recommend for administration to the user 102 to manage the symptom; however, it is to be appreciated that the claimed subject matter is not so limited.

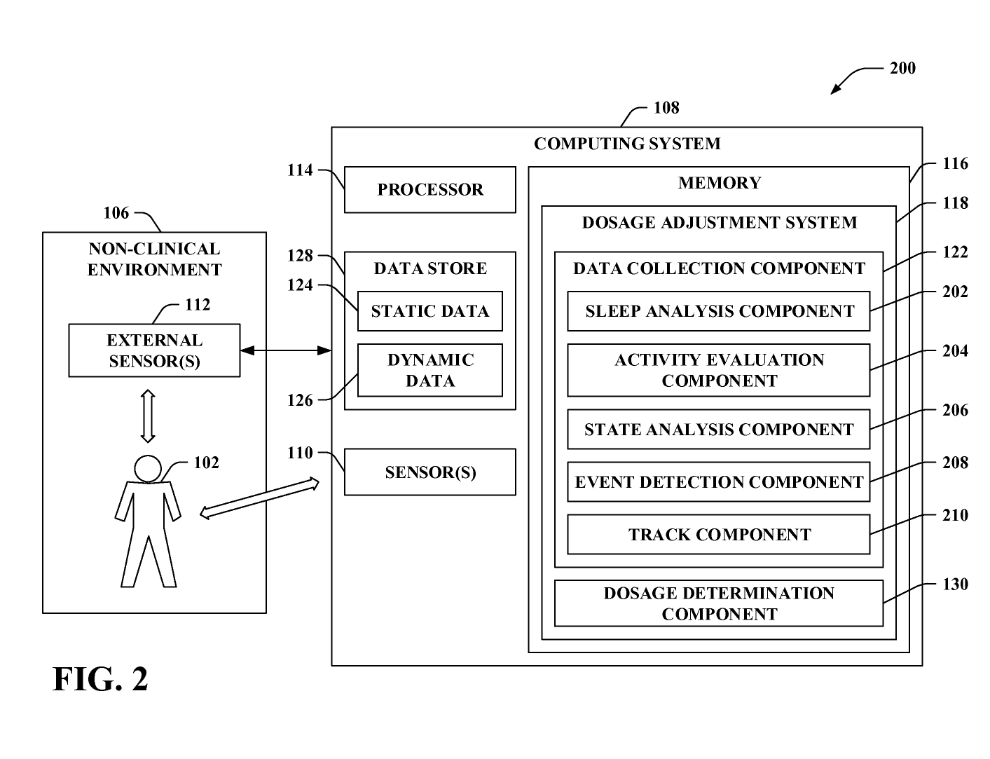

Turning to FIG. 2, illustrated is a system 200 that uses the sensor(s) 110 of the computing system 108 and/or the external sensor(s) 112 as well as demographic data of the user 102 to automatically adjust recommended dosages of a medication (e.g., the medication 104) in the non-clinical environment 106. Again, according to various examples, it is contemplated that the computing system 108 can be within proximity of the user 102 in the non-clinical environment 106; however, pursuant to other examples, the computing system 108 need not be within proximity of the user 102. The data collection component 122 of the dosage adjustment system 118 can track various metrics from data obtained via the sensor(s) 110 of the computing system 108 and/or the external sensor(s) 112 to collect the dynamic data 126 indicative of the efficacy of the medication for the user 102 over time in the non-clinical environment 106. Further, the dosage determination component 130 can refine recommended dosages of the medication based at least in part on the dynamic data 126 indicative of the efficacy of the medication for the user 102 over time in the non-clinical environment 106 as tracked by the data collection component 122 (e.g., based on the various metrics).

The data collection component 122 can include a sleep analysis component 202 that can analyze quantity and/or quality of sleep of the user 102. The sleep analysis component 202 can receive data from at least one of the sensor(s) 110 and/or the external sensor(s) 112 in the non-clinical environment 106. Further, the sleep analysis component 202 can detect the quantity of the sleep of the user 102 and/or the quality of the sleep of the user 102 based upon the data from the sensor(s) 110 and/or the external sensor(s) 112. The dosage determination component 130 can determine recommended dosages of the medication for the user 102 based upon the quantity of the sleep of the user 102 and/or the quality of the sleep of the user 102.

Quantity and/or quality of sleep may be informative of side effects since medications may cause drowsiness or sleeplessness; thus, the dosage determination component 130 can adjust recommended dosages of the medication to mitigate such side effects while managing the symptom for the user 102. Moreover, the quantity and/or quality of sleep can be a target effect of the medication (e.g., the dosage determination component 130 can adjust the recommended dosage of the medication to refine an amount of sleep or minimize drowsiness after the user 102 wakes up). The sleep analysis component 202 can track sleep from bedside sensors, motion data and/or physiological data.

The sleep analysis component 202 can detect when the user 102 falls asleep and when the user 102 wakes up to determine the quantity of sleep of the user 102. For instance, from motion data, the sleep analysis component 202 can detect when the user 102 stops moving and when the user 102 starts moving at a later point in time to determine the amount of sleep for the user 102.

According to an example, the external sensor(s) 112 can include a wearable sensor that can sense motion of the user 102 during sleep. The wearable sensor, for instance, can be a watch or a sensor that can clip to an article of clothing worn by the user 102. Utilizing data from the wearable sensor that senses motion, the sleep analysis component 202 can determine how much the user 102 moves during sleep, whether the user 102 wakes up during a sleep period, frequency and duration of waking up during a sleep period, a length of time prior to falling asleep, or the like. Moreover, the sleep analysis component 202 can determine the quality of sleep and/or the quantity of sleep of the user 102 based upon the foregoing evaluation (e.g., lower quality sleep can be associated with more frequent waking up of the user 102 as evidenced by increased motion of the user 102, etc.).

Pursuant to another example, the external sensor(s) 112 can include an electrophysiological sensor of sleep. Following this example, the electrophysiological sensor of sleep can be a consumer grade electroencephalogram (EEG), which can be included in a headband to measure brain activity of the user 102. The sleep analysis component 202 can receive data from such sensor to analyze the sleep of the user 102.

The external sensor(s) 112, for example, can further include other types of sensors that measure physiological indicators pertaining to sleep, such as heart rate or pulse information. For instance, a pulse rate of the user 102 can be measured from a watch worn by the user 102 while sleeping. Again, the sleep analysis component 202 can receive data from these sensors to evaluate the quality and/or quantity of sleep.

Moreover, the external sensor(s) 112 and/or the sensor(s) 110 can include a bedside sensor. The bedside sensor can include a camera, a microphone, a combination there, and so forth. The bedside sensor can enable the sleep analysis component 202 to evaluate the quality and/quantity of sleep (e.g., motion of the user 102 can be measured by the sleep analysis component 202 based on video and/or audio obtained from the bedside sensor).

According to another example, the external sensor(s) 112 can include a bed-embedded sensor. For instance, the bed-embedded sensor can be pressure sensor or motion sensor incorporated into a bed, which can provide data to the sleep analysis component 202 for evaluation.

Pursuant to yet another example, the sleep analysis component 202 can measure congestion experienced by the user 102. Following this example, the external sensor(s) 112 can include a chest band that includes a microphone and a sensor to measure pulse oxygenation (pulse O₂) and chest compression. The sleep analysis component 202 can obtain the information from such chest band and can correlate information to congestion. By way of another example, audio sensors (e.g., microphone, wearable audio sensors, bedside audio sensors, etc.) can be utilized by the sleep analysis component 202 to measure snoring or congestion of the user 102.

The data collection component 122 can further include an activity evaluation component 204 that tracks an activity level of the user 102 from motion data, audio data, physiological data, and so forth. The activity evaluation component 204 can receive data from at least one of the sensor(s) 110 and/or the external sensor(s) 112 in the non-clinical environment 106; based upon such data, the activity evaluation component 204 can track the activity level of the user 102. For instance, medications may cause drowsiness or hyperactivity as side effects, which can correspond to the activity level of the user 102. The dosage determination component 130 can further determine recommended dosages of the medication for the user 102 based upon the activity level of the user 102.

By way of example, the activity evaluation component 204 can estimate the activity level of the user 102 from motion of the user 102. For instance, the activity evaluation component 204 can receive motion data of the user 102 from a wearable sensor (e.g., sensor-equipped watch or garment, etc.) in the non-clinical environment 106 over time. According to another illustration, the motion data evaluated by the activity evaluation component 204 can be obtained from the sensor(s) 110 of the computing system 108.

Moreover, physiological data (e.g., heart rate, etc.) can be obtained by the activity evaluation component 204 from the wearable sensor (e.g., sensor-equipped watch or garment) or other environmental sensor(s). The physiological data can be an indicator of the activity level of the user 102, which can correspond to drowsiness or hyperactivity of the user 102.

The activity evaluation component 204 can also infer whether the user 102 performs an activity of daily living based upon the data from the sensor(s) 110 and/or the external sensor(s) 112. For instance, the activity evaluation component 204 can infer whether the user 102 performs activities of daily living such as brushing her teeth, preparing food, showering, going to work, and so forth. The inferred activities determined by the activity evaluation component 204 can be analyzed to diagnose symptoms, such as depression and whether other ill effects are being experienced by the user 102. For instance, the activity evaluation component 204 can utilize data from a Global Positioning System (GPS) sensor (e.g., the sensor(s) 110 and/or the external sensor(s) 112 can include the GPS sensor) to aid inferring the activities performed by the user 102. Additionally or alternatively, the activity evaluation component 204 can infer the activities of daily living utilizing wearable sensors or other external sensor(s) 112 around the non-clinical environment 106 that can collect information pertaining to activities performed by the user 102 (e.g., cameras within a home of the user 102).

The data collection component 122 can also include a state analysis component 206 that can evaluate a mood, cognitive impairment or other subjective state of the user 102. The mood, cognitive impairment or other subjective state related information can be informative since medications may cause irritability or dizziness as side effects. Moreover, mood regulation can be a primary target of the medication (e.g., the symptom of the user 102 desirably managed by the medication). Thus, the dosage determination component 130 can determine recommended dosages of the medication for the user 102 based upon the mood, cognitive impairment or other subjective state of the user 102.

By way of example, the data collection component 122 (e.g., the state analysis component 206) can generate a survey for the user 102. Further, the data collection component 122 can receive feedback information from the user 102 responsive to the survey. The survey can prompt the user 102 for responses pertaining to mood, cognitive impairment, or subjective state; however, it is to be appreciated that the survey can additionally or alternatively prompt the user 102 for other types of responses. Moreover, the dynamic data 126 indicative of the efficacy of the medication for the user 102 can be identified based upon the feedback information responsive to the survey. Pursuant to an illustration, the state analysis component 206 can collect data pertaining to the state of the user 102 via active surveys deployed to sample an experience of the user 102. The state analysis component 206 can cause a survey to be displayed to the user 102 (e.g., on a display screen of the computing system 108, on a display screen separate from the computing system 108, etc.) to collect feedback information from the user 102 before and/or after administration of the medication, where the feedback pertains to the mood, cognitive impairment or other subjective state of the user 102. For instance, the state analysis component 206 can cause the survey to be deployed a predetermined amount of time after the user 102 takes a dose of the medication; however, the claimed subject matter is not so limited.

According to another example, the state analysis component 206 can identify the mood, cognitive impairment or other subjective state of the user 102 based upon data received from at least one of the sensor(s) 110 and/or the external sensor(s) 112 (e.g., physiological sensors, cameras, microphones, etc.). For instance, heart rate variability can correspond to the state of the user 102. Further, data from physiological sensors that sense skin properties of the user 102 can be evaluated by the state analysis component 206 due to correlations between the skin properties and the state of the user 102. Moreover, data from automated sensors, such as cameras and microphones, can be utilized by the state analysis component 206 to measure facial expressions, voice tones and/or body language of the user 102, which can be informative as to the state of the user 102. It is also contemplated that the state analysis component 206 can utilize information obtained by the sleep analysis component 202 and/or the activity evaluation component 204 to analyze the state of the user 102.

By way of yet another example, the state analysis component 206 can receive a cognitive state indicator for the user 102 from a social network service. The cognitive state indicator can be a function of social activity data of the user 102 on the social network service. The social activity data, for instance, can include comments made by the user 102 or to the user 102, relationships of the user 102 created or removed, posts, statuses, shared content, indications of affinity for content, and so forth. Further, the state analysis component 206 can identify the mood, cognitive impairment or other subjective state of the user 102 based upon the cognitive state indicator for the user 102.

Moreover, the data collection component 122 can include an event detection component 208 that can detect physiological events, such as coughing, sneezing, vomiting, tremors, etc., which may be side effects of the medication or may be the symptom of the user 102 desirably managed by the medication. The event detection component 208 can detect a number of occurrences of a physiological event of the user 102 based upon data received from the sensor(s) 110 and/or the external sensor(s) 112 in the non-clinical environment 106. For instance, the medication can be a cough suppressant; thus, the event detection component 208 can detect a number of coughs of the user 102 within a period of time.

The data collection component 122 can further include a track component 210 that tracks physiological indicators such as breathing, blood pressure, heart rate, or the like. The track component 210 can track a physiological indictor of the user 102 based upon data received from the sensor(s) 110 and/or the external sensor(s) 112 in the non-clinical environment 106. The physiological indicators can be indicative of pain, hyperactivity/hypoactivity or may be directly manipulated as side effects of a medication. Moreover, the track component 210 can collect information pertaining to blood sugar level of the user 102, oxygenation levels of the user 102, hydration of the user 102, rashes experienced by the user 102, body temperature of the user 102, and so forth.

By way of example, a potential side effect of a cold medication can be tachycardia (e.g., increased heart rate). Accordingly, the track component 210 can monitor the heart rate of the user 102 to detect such side effect. The dosage determination component 130 can refine the subsequent recommended dosage of medication based upon such information.

According to another example, hydration of the user 102 can be detected by the track component 210. For instance, a mechanical sensor that can push on the skin of the user 102 can be utilized, and the track component 210 can analyze how the skin responds to such mechanical deformation. According to other illustrations, hydration of the user 102 can be detected using a retainer that automatically detects whether the mouth of the user 102 is dry or wet, a camera can capture an image of the mouth which can be evaluated by the track component 210 to determine whether the mouth of the user is dry or wet, or the like.

According to another example, the track component 210 can utilize an image captured by a camera to identify a rash. The rash can be the symptom of the user 102 desirably managed by the medication or a side effect of the medication (e.g., allergic reaction to the medication).

By way of yet another example, the track component 210 can evaluate eye dilation. For instance, the external sensor(s) 112 can include glasses with cameras pointed towards the eye, which can collect information pertaining to physiological markers that can be continuously sensed for reactions to medications by the track component 210.

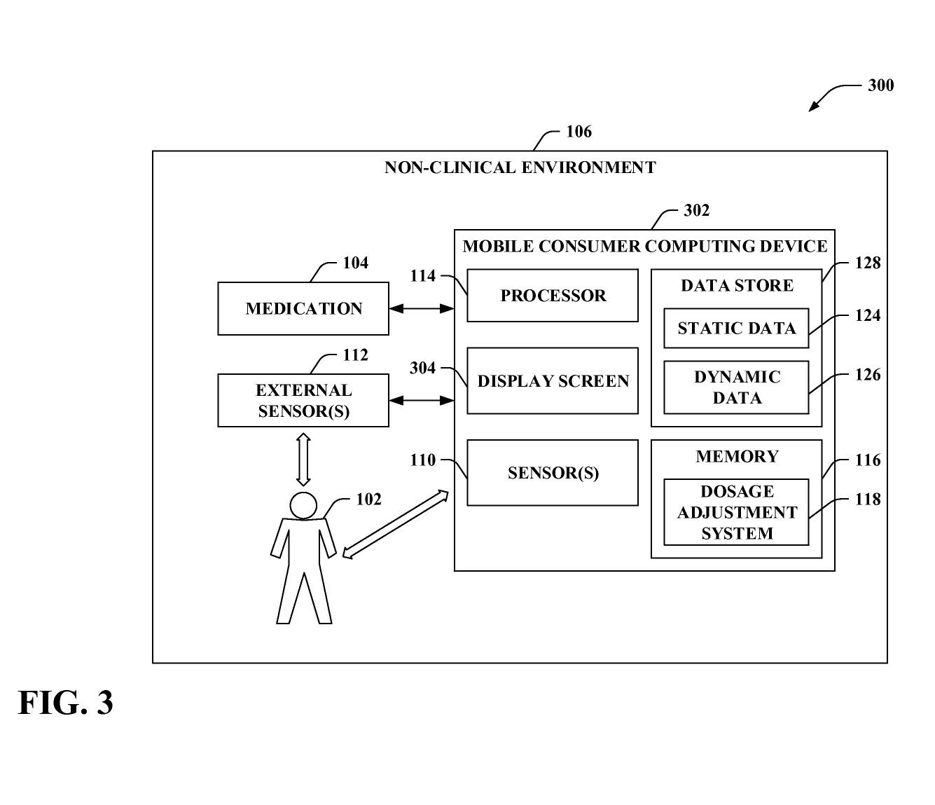

Turning to FIG. 3, illustrated is a system 300 that adjusts recommended dosages of the medication 104 for the user 102 in the non-clinical environment 106. As shown in the example of FIG. 3, a mobile consumer computing device 302 is in the non-clinical environment 106 within proximity of the user 102. While the mobile consumer computing device 302 is depicted, it is to be appreciated that other types of computing systems can alternatively be within proximity of the user 102 in the non-clinical environment 106.

The mobile consumer computing device 302 can include the processor 114, the memory 116, the data store 128, and the sensor(s) 110. Moreover, the mobile consumer computing device 302 can include a display screen 304. As described above, the dosage adjustment system 118 can cause information indicative of the recommended dosages to be presented to the user 102 via the display screen 304. Additionally or alternatively, a survey generated by the dosage adjustment system 118 can be displayed via the display screen 304.

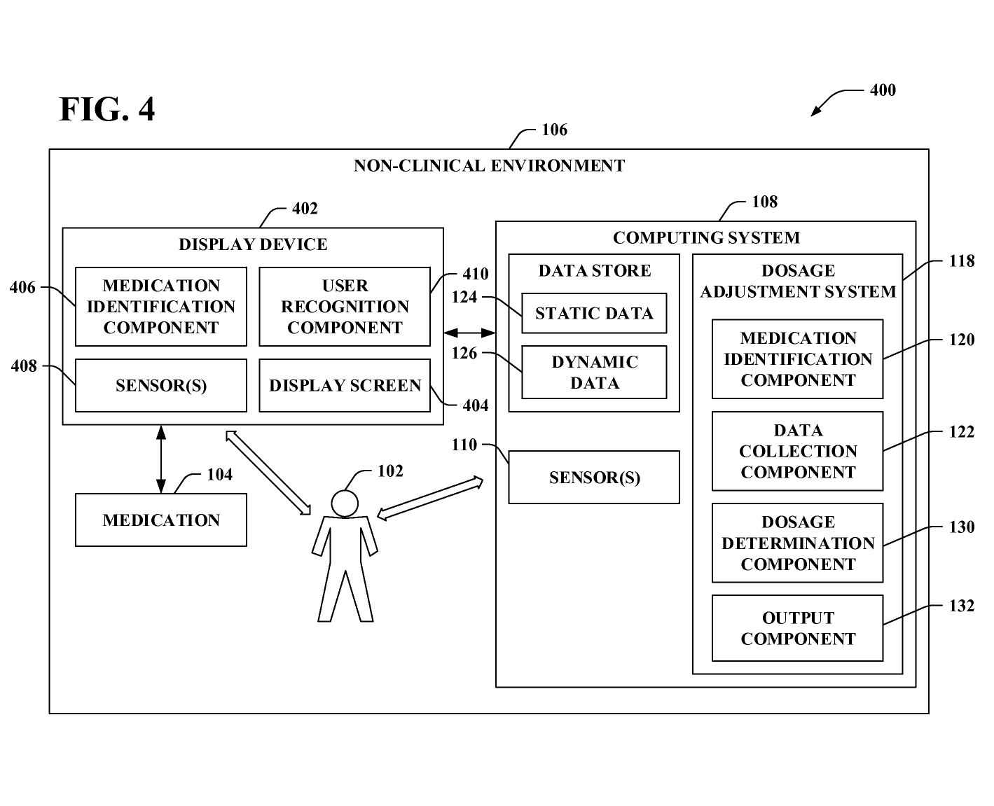

With reference to FIG. 4, illustrated is a system 400 that employs a display device 402 in the non-clinical environment 106 to display recommended dosages of the medication 104 for the user 102. The display device 402 can communicate (e.g., wirelessly) with the computing system 108 (e.g., the mobile consumer computing device 302). Again, it is contemplated that the computing system 108 can be in the non-clinical environment 106 within proximity of the user 102; alternatively, the computing system 108 need not be within proximity of the user 102. The display device 402 includes a display screen 404.

As described above, the dosage determination component 130 of the computing system 108 can determine recommended dosages of the medication 104 for the user 102. Moreover, the output component 132 of the computing system 108 can send information indicative of the recommended dosages of the medication 104 to the display device 402, thereby causing such recommended dosage information to be presented on the display screen 404 of the display device 402. Accordingly, the display screen 404 can present user specific information indicative of recommended dosages of the medication 104 received from the computing system 108. For instance, the display device 402 can present the recommended dosages of the medication 104 for the user 102 as personalized on a custom medication container that replaces or includes an existing medication container (e.g., replacing a generic label or static label of the medication container with a user specific label).

According to various embodiments, the display device 402 can be a sleeve; thus, a medication container for the medication 104 can be positioned within an opening of the sleeve and the recommended dosages of the medication 104 determined by the dosage determination component 130 of the computing system 108 over time can be displayed on the display screen 404 of the sleeve. According to other embodiments, the display device 402 can be a sticker that can be affixed to or integrated into a medication container for the medication 104. The sticker can include an active display (e.g., the display screen 404) that can display the recommended dosages of the medication 104 determined by the dosage determination component 130 of the computing system 108 over time. Pursuant to other embodiments, the display device 402 can be the medication container of the medication 104, and such medication container can include the display screen 404. However, it is to be appreciated that other form factors for the display device 402 are intended to fall within the scope of the hereto appended claims (e.g., the display device 402 can be a lid that can removeably connect with the medication container, the display device 402 need not physically connect with the medication container, etc.). Moreover, it is contemplated that the display device 402 can be reusable for differing medication containers (e.g., for the same or differing medications).

Further, the display device 402 can include the medication identification component 406 that identifies the medication 104. Moreover, the display device 402 can include one or more sensor(s) 408 (e.g., the external sensor(s) 112 can be or include the sensor(s) 408). Similar to the medication identification component 120 of the computing system 108, the medication identification component 406 can identify the medication 104 (e.g., utilizing the sensor(s) 408, based upon received user input, etc.). The medication identification component 406 can send information that specifies the identified medication 104 to the computing system 108; thus, the medication identification component 120 of the computing system 108 can receive the information from the display device 402 to identify the medication 104.

The medication identification component 406 can scan (e.g., utilizing the sensor(s) 408) a medication container of the medication 104 for identifying information, for example. The sensor(s) 408, for instance, can include a camera, an RFID reader, a combination thereof, or the like, which can capture information from the medication container of the medication 104. Further, the medication identification component 406 can detect the medication 104 based upon the captured information.

The display device 402 can also include a user recognition component 410 that can identify the user 102 so as to provide recommended dosage information that is personalized for such user 102. For instance, the user recognition component 410 can authenticate the user 102 by employing a camera, biometric scanner (e.g., fingerprint scanner, iris scanner, etc.), pass code, or the like (e.g., one or more of the sensor(s) 408 of the display device 402). Further, the user recognition component 410 can enable the personalized recommended dosage information to remain private for the user 102 (e.g., a disparate user may be unable to view the personalized recommended dosage information for the user 102).

It is further contemplated that the display device 402 (e.g., the sensor(s) 408 of the display device 402) can be employed by the data collection component 122 to collect at least a portion of the dynamic data 126 indicative of the efficacy of the medication 104 for the user 102 over time in the non-clinical environment 106. Thus, information obtained by the sensor(s) 408 of the display device 402 can be sent from the display device 402 to the computing system 108 (e.g., to the data collection component 122). Accordingly, the dosage determination component 130 can refine recommended dosages of the medication 104 based on such data collected by the display device 402. By way of illustration, the sensor(s) 408 of the display device 402 can include a camera, a microphone, a blood pressure cuff, or the like. Following this illustration, information collected by such sensor(s) 408 can be sent to the computing system 108.

According to an example, the display device 402 can cover at least a portion of a medication container of the medication 104. For instance, the display device 402 can obscure generic dosage information or static dosage information for the user 102 printed on a label of the medication container. By way of illustration, the label of the medication container can specify a generic dose of 5 mg of the medication 104. However, based on the personalized data obtained by the data collection component 122, the dosage determination component 130 of the computing system 108 can determine a recommended dosage of the medication 104 for the user 102 of 3.2 mg. Thus, the display device 402 can obscure the generic dosage information printed on the label of the medication container of the medication 104 and the personalized recommended dosage of 3.2 mg of the medication 104 for the user 102 can be displayed on the display screen 404. It is to be appreciated, however, that the claimed subject matter is not so limited.

According to various embodiments, it is also contemplated that the display device 402 can dispense medication. For instance, the medication 104 can be poured into the display device 402 (e.g., the display device 402 can include a chamber that can store the medication 104). Further, the display device 402 can automatically dispense a dose of the medication 104 based on the recommended dosage of the medication 104 determined by the dosage determination component 130.

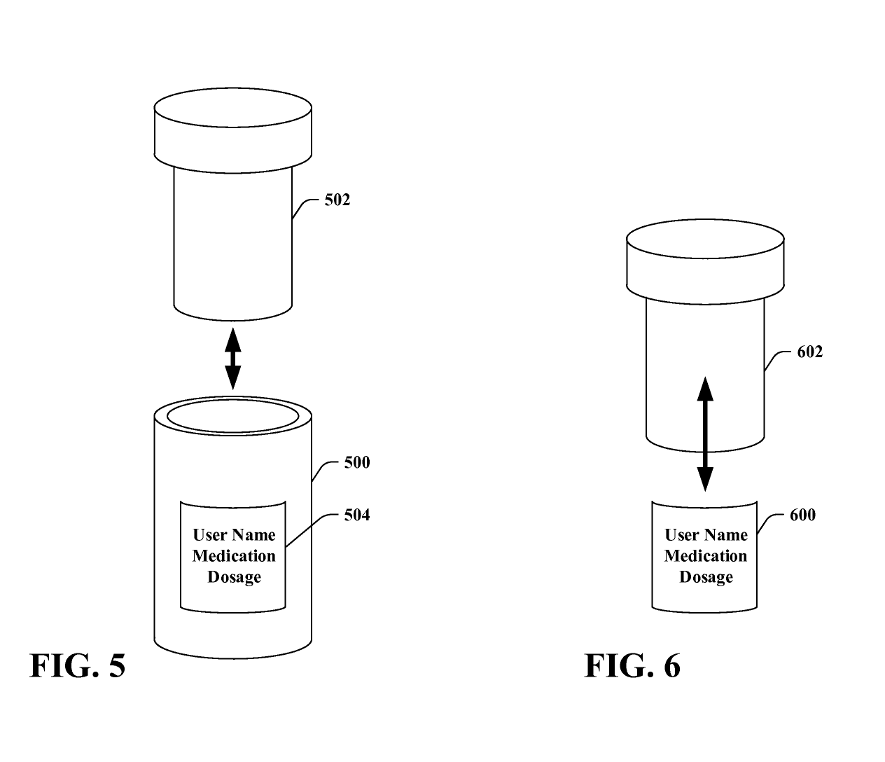

Now turning to FIG. 5, illustrated is an exemplary display device 500 according to various embodiments. As depicted, the display device 500 is a sleeve that forms an opening configured to receive the medication container 502. Although not shown, it is to be appreciated that the medication container 502 can have a label that includes generic dosing information printed thereupon (e.g., for OTC medications, for some non-OTC medications, etc.). Moreover, for some non-OTC medications, the medication container 502 can have a label printed with static dosage information for a user.

The display device 500 includes a display screen 504 that displays information such as a name of the user, a name of the medication, and personalized recommended dosage information for the user. The display screen 504 can update the recommended dosage information for the user displayed on the display screen 504 over time (e.g., as refined by the dosage determination component 130) based upon detected feedback.

By way of illustration, the medication container 502 can be positioned in the opening defined by the display device 500 (e.g., the sleeve). When the medication container 502 is positioned in the opening defined by the display device 500, the display device 500 can cover the generic dosing information or the static dosage information for the user printed on the label of the medication container 502. In addition to obscuring the generic dosing information or the static dosage information printed on the label of the medication container 502 (e.g., by surrounding at least a portion of the medication container 502), the display device 500 can present personalized recommended dosage information that is adjusted over time based on the static data of the user and the dynamic data indicative of the efficacy of the medication.

According to another example, upon insertion of the medication container 502 of the medication into the opening defined by the display device 500, the display device 500 can identify the medication. For instance, data captured by a camera, an RFID reader, or other sensor of the display device 500 can be evaluated to identify the medication when the medication container 502 is inserted into the opening defined by the display device 500. Moreover, the display device 500 can be a reusable sleeve; thus, the display device 500 can detect removal of the medication container 502 from the opening, detect an identity of a disparate medication upon insertion of a differing medication container of the disparate medication into the opening defined by the display device 500, and so forth.

With reference to FIG. 6, illustrated is another exemplary display device 600 according to various embodiments. The display device 600 is a label that can be affixed to a medication container 602. Again, it is contemplated that the medication container 602 can have a label that includes generic dosage information or static dosage information printed thereupon. The display device 600 can be affixed over the label of the medication container 602 to obscure the generic dosage information or the static dosage information.

Similar to the display device 500 of FIG. 5, the display device 600 include a display screen that displays information such as the name of the user, the name of the medication, and personalized recommended dosage information of the medication for the user. Again, the recommended dosage information can be dynamically updated over time based upon detected feedback.

According to various embodiments, the display device 600 can be removable from the medication container 602 and reusable (e.g., on a disparate medication container for the same and/or a different medication). Thus, the display device 600 can be attached to the medication container 602; thereafter, the display device 600 can be removed from the medication container 602 and attached to a differing medication container.

In accordance with other embodiments, the display device 600 can be embedded directly into the medication container 602. Accordingly, the display device 600 can be disposed of with the medication container 602.

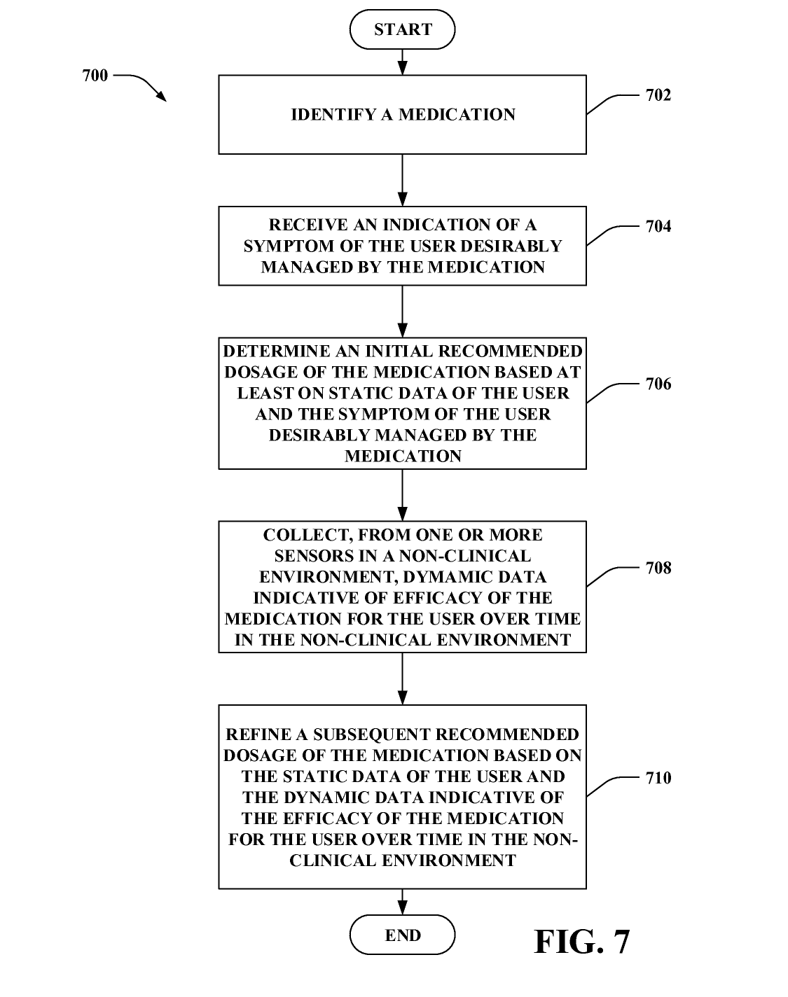

FIGS. 7-9 illustrate exemplary methodologies relating to utilizing sensors and demographic data to automatically adjust recommended dosages of a medication. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 7 illustrates a methodology 700 of adjusting recommended dosages of a medication. At 702, the medication can be identified. The recommended dosages of the medication can desirably be personalized for a user. At 704, an indication of a symptom of the user desirably managed by the medication can be received. At 706, an initial recommended dosage of the medication can be determined based at least on static data of the user and the symptom of the user desirably managed by the medication. At 708, dynamic data indicative of efficacy of the medication for the user over time can be collected in a non-clinical environment from one or more sensors in the non-clinical environment. The dynamic data indicative of the efficacy of the medication for the user over time in the non-clinical environment can include data indicative of the symptom of the user desirably managed by the medication and data indicative of a side effect of the user resulting from the medication. At 710, a subsequent recommended dosage of the medication can be refined based on the static data of the user and the dynamic data indicative of the efficacy of the medication for the user over time in the non-clinical environment.

Moreover, the dynamic data indicative of the efficacy of the medication for the user over time can continue to be collected (e.g., while the user continues to take the medication) in the non-clinical environment from the one or more sensors in the non-clinical environment. Thus, subsequent recommended dosage(s) of the medication can continue to be refined based on the static data of the user and the dynamic data indicative of the efficacy of the medication for the user over time in the non-clinical environment.

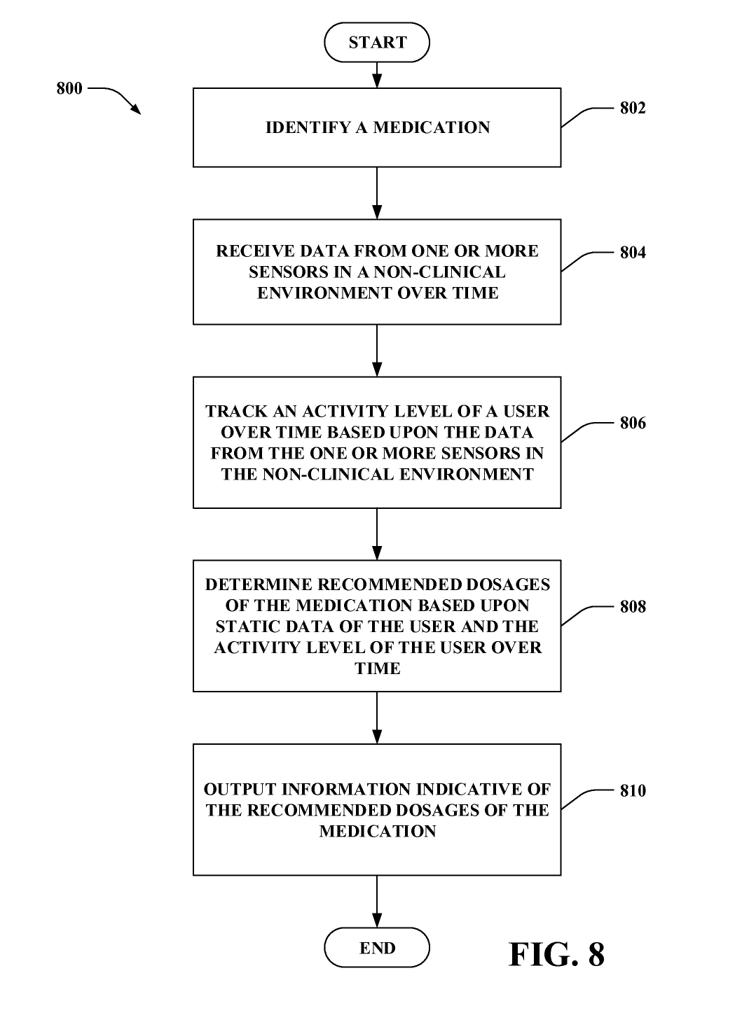

With reference to FIG. 8, illustrated is a methodology 800 of adjusting recommended dosages of a medication. At 802, a medication can be identified, where recommended dosages of the medication are desirably personalized for a user to manage a symptom of the user. At 804, data can be received from one or more sensors in a non-clinical environment over time. At 806, an activity level of the user can be tracked over time based upon the data from the one or more sensors in the non-clinical environment. The activity level can be indicative of the symptom of the user desirably managed by the medication or a side effect of the user resulting from the medication. At 808, the recommended dosages of the medication can be determined based upon static data of the user and the activity level of the user over time. At 810, information indicative of the recommended dosages of the medication can be output.

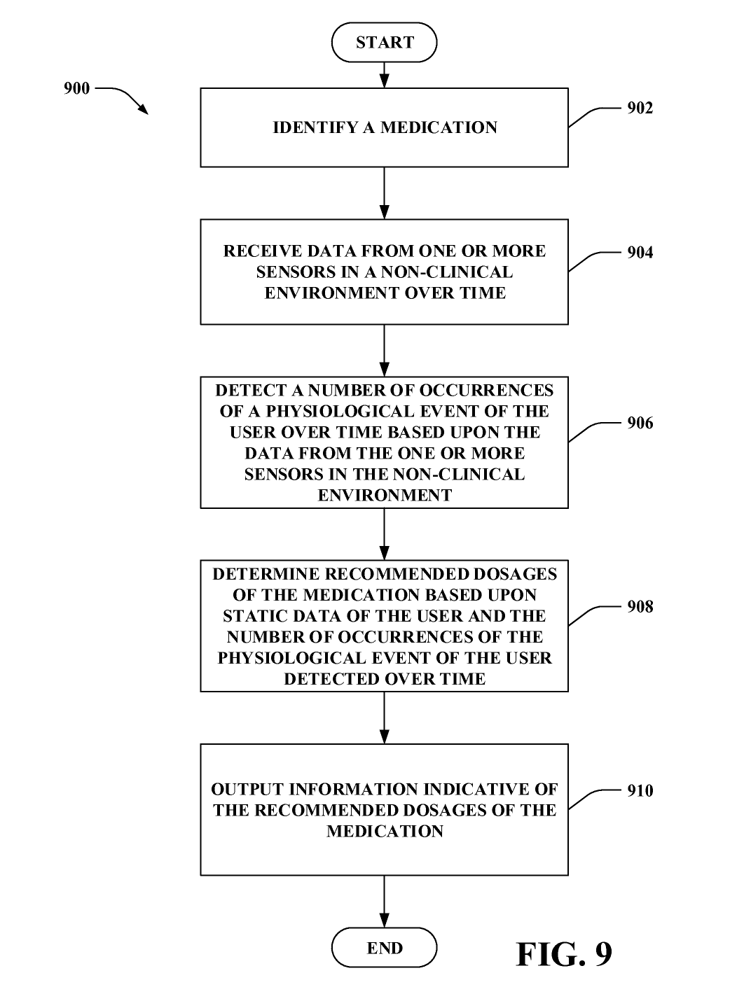

Turning to FIG. 9, illustrated is a methodology 900 of adjusting recommended dosages of a medication. At 902, a medication can be identified, where recommended dosages of the medication are desirably personalized for a user to manage a symptom of the user. At 904, data can be received from one or more sensors in a non-clinical environment over time. At 906, a number of occurrences of a physiological event of the user can be detected over time based upon the data from the one or more sensors in the non-clinical environment. The number of occurrences of the physiological event of the user can be indicative of the symptom of the user desirably managed by the medication or a side effect of the user resulting from the medication. At 908, the recommended dosages of the medication can be determined based upon static data of the user and the number of occurrences of the physiological event of the user detected over time. At 910, information indicative of the recommended dosages of the medication can be output.

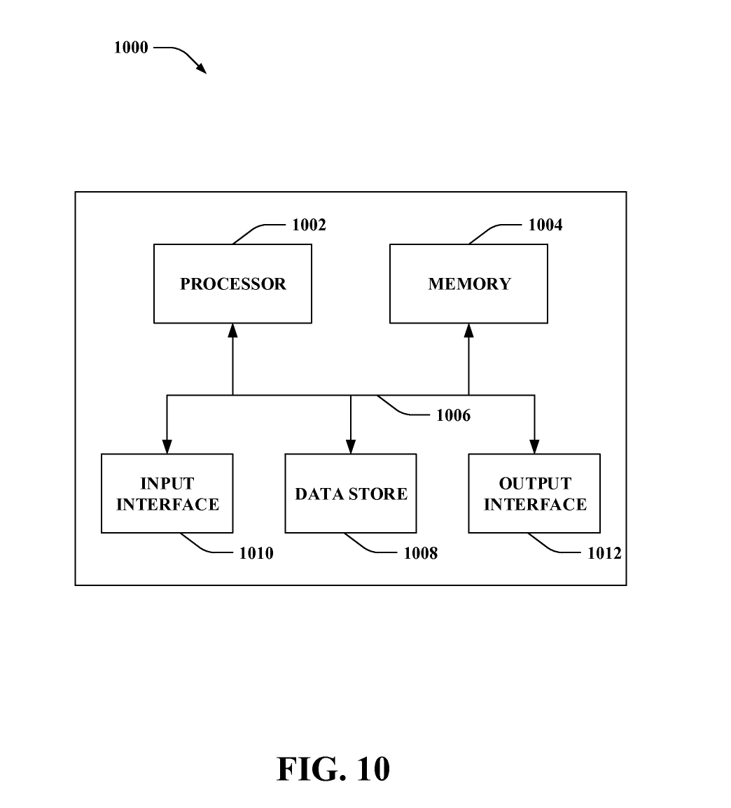

Referring now to FIG. 10, a high-level illustration of an exemplary computing device 1000 that can be used in accordance with the systems and methodologies disclosed herein is illustrated. For instance, the computing device 1000 may be utilized in a system that uses sensors and demographic data of a user to automatically adjust recommended dosages of a medication for the user in a non-clinical environment. By way of example, the computing device 1000 may be the computing system 108 (e.g., the mobile consumer computing device 302, etc.). According to another example, the computing device 1000 can be the display device 402. The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store information indicative of a type of medication, static data of a user, information pertaining to a symptom of the user desirably managed by a medication, dynamic data indicative of efficacy of the medication for the user over time in the non-clinical environment, historical dosage information, and so forth.

The computing device 1000 additionally includes a data store 1008 that is accessible by the processor 1002 by way of the system bus 1006. The data store 1008 may include executable instructions, information indicative of a type of medication, static data of a user, information pertaining to a symptom of the user desirably managed by a medication, dynamic data indicative of efficacy of the medication for the user over time in the non-clinical environment, historical dosage information, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

It is contemplated that the external devices that communicate with the computing device 1000 via the input interface 1010 and the output interface 1012 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1000 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1000 may be a distributed system. Thus, for instance, several devices may be in communication by way of a network connection and may collectively perform tasks described as being performed by the computing device 1000.

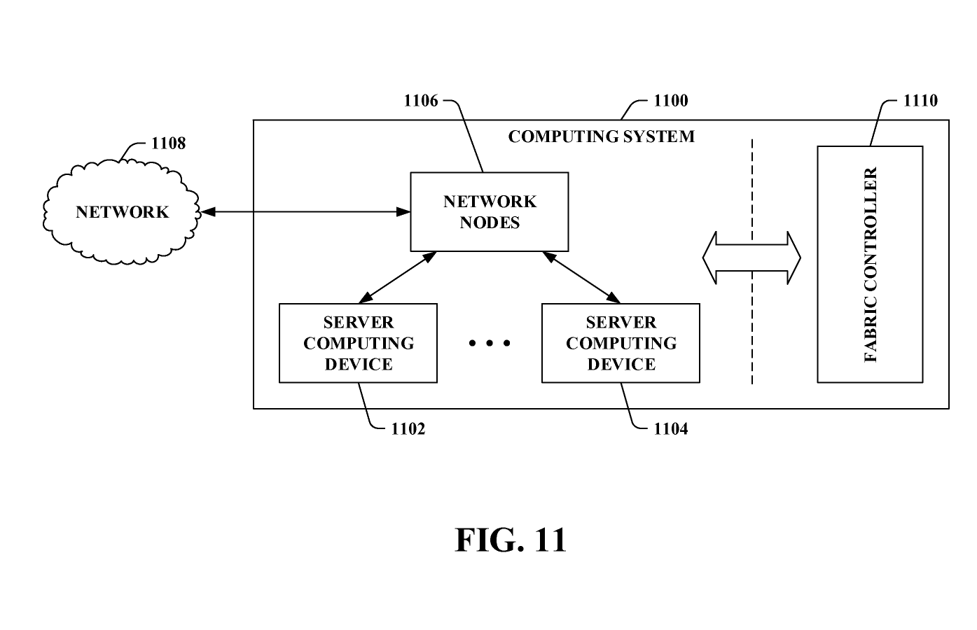

Turning to FIG. 11, a high-level illustration of an exemplary computing system 1100 that can be used in accordance with the systems and methodologies disclosed herein is illustrated. For instance, the computing system 1100 can be or include the computing system 108. Additionally or alternatively, the computing system 108 can be or include the computing system 1100.

The computing system 1100 includes a plurality of server computing devices, namely, a server computing device 1102, . . . , and a server computing device 1104 (collectively referred to as server computing devices 1102-1104). The server computing device 1102 includes at least one processor and a memory; the at least one processor executes instructions that are stored in the memory. The instructions may be, for instance, instructions for implementing functionality described as being carried out by one or more components discussed above or instructions for implementing one or more of the methods described above. Similar to the server computing device 1102, at least a subset of the server computing devices 1102-1104 other than the server computing device 1102 each respectively include at least one processor and a memory. Moreover, at least a subset of the server computing devices 1102-1104 include respective data stores.

Processor(s) of one or more of the server computing devices 1102-1104 can be or include the processor 114. Further, a memory (or memories) of one or more of the server computing devices 1102-1104 can be or include the memory 116. Moreover, a data store (or data stores) of one or more of the server computing devices 1102-1104 can be or include the data store 128.

The computing system 1100 further includes various network nodes 1106 that transport data between the server computing devices 1102-1104. Moreover, the network nodes 1102 transport data from the server computing devices 1102-1104 to external nodes (e.g., external to the computing system 1100) by way of a network 1108. The network nodes 1102 also transport data to the server computing devices 1102-1104 from the external nodes by way of the network 1108. The network 1108, for example, can be the Internet, a cellular network, or the like. The network nodes 1106 include switches, routers, load balancers, and so forth.

A fabric controller 1110 of the computing system 1100 manages hardware resources of the server computing devices 1102-1104 (e.g., processors, memories, data stores, etc. of the server computing devices 1102-1104). The fabric controller 1110 further manages the network nodes 1106. Moreover, the fabric controller 1110 manages creation, provisioning, de-provisioning, and supervising of virtual machines instantiated upon the server computing devices 1102-1104.

Various examples are now set forth.

### Example 1

A method of adjusting recommended dosages of a medication, comprising: identifying the medication, wherein the recommended dosages of the medication are desirably personalized for a user; receiving an indication of a symptom of the user desirably managed by the medication; determining an initial recommended dosage of the medication based at least on static data of the user and the symptom of the user desirably managed by the medication; collecting, from one or more sensors in a non-clinical environment, dynamic data indicative of efficacy of the medication for the user over time in the non-clinical environment, wherein the dynamic data indicative of the efficacy of the medication for the user over time in the non-clinical environment comprises: data indicative of the symptom of the user desirably managed by the medication; and data indicative of a side effect of the user resulting from the medication; and refining a subsequent recommended dosage of the medication based on the static data of the user and the dynamic data indicative of the efficacy of the medication for the user over time in the non-clinical environment.

### Example 2

The method according to Example 1, further comprising receiving the static data of the user from at least one of a personal health record service or a social network service.

### Example 3

The method according to any of Examples 1-2, wherein the static data of the user comprises information indicative of one or more of a known allergy of the user, a known response of the user to a differing medication in a class that includes the medication, previous medical history of the user, or previous emotional state history of the user for medications that have possible psychoactive side effects.

### Example 4

The method according to any of Examples 1-3, collecting the dynamic data indicative of the efficacy of the medication for the user further comprises: receiving data from the one or more sensors in the non-clinical environment; and detecting at least one of a quantity of sleep of the user or a quality of the sleep of the user based upon the data from the one or more sensors in the non-clinical environment; wherein the subsequent recommended dosage of the medication is refined based upon the quantity of the sleep of the user or the quality of the sleep of the user.

### Example 5

The method according to any of Examples 1-4, collecting the dynamic data indicative of the efficacy of the medication for the user further comprises: receiving data from the one or more sensors in the non-clinical environment; and tracking an activity level of the user based upon the data from the one or more sensors in the non-clinical environment; wherein the subsequent recommended dosage of the medication is refined based upon the activity level of the user.

### Example 6

The method according to any of Examples 1-5, collecting the dynamic data indicative of the efficacy of the medication for the user further comprises: receiving data from the one or more sensors in the non-clinical environment; and identifying at least one of a mood or a cognitive impairment of the user based upon the data from the one or more sensors in the non-clinical environment; wherein the subsequent recommended dosage of the medication is refined based upon the mood or the cognitive impairment of the user.

### Example 7

The method according to any of Examples 1-6, further comprising: receiving a cognitive state indicator for the user from a social network service; and identifying at least one of a mood or a cognitive impairment of the user based upon the cognitive state indicator for the user; wherein the subsequent recommended dosage of the medication is refined based upon the mood or the cognitive impairment of the user.

### Example 8

The method according to any of Examples 1-7, collecting the dynamic data indicative of the efficacy of the medication for the user further comprises: receiving data from the one or more sensors in the non-clinical environment; and detecting a number of occurrences of a physiological event of the user based upon the data from the one or more sensors in the non-clinical environment; wherein the subsequent recommended dosage of the medication is refined based upon the number of occurrences of the physiological event of the user.

### Example 9

The method according to any of Examples 1-8, collecting the dynamic data indicative of the efficacy of the medication for the user further comprises: receiving data from the one or more sensors in the non-clinical environment; and tracking a physiological indicator of the user based upon the data from the one or more sensors in the non-clinical environment; wherein the subsequent recommended dosage of the medication is refined based upon the physiological indicator of the user.

### Example 10

The method according to any of Examples 1-9, further comprising: generating a survey for the user; receiving feedback information from the user responsive to the survey; and identifying the dynamic data indicative of the efficacy of the medication for the user based upon the feedback information responsive to the survey.

### Example 11

The method according to any of Examples 1-10 executed by a mobile consumer computing device in the non-clinical environment.

### Example 12

The method according to any of Examples 1-11, further comprising: transmitting information indicative of the recommended dosages of the medication to a display device, the information indicative of the recommended dosages being presented upon a display screen of the display device.

### Example 13

A computing system, comprising: a processor; and a memory that comprises a dosage adjustment system that is executable by the processor, the dosage adjustment system comprising: a medication identification component configured to identify a medication, wherein recommended dosages of the medication are desirably personalized for a user to manage a symptom of the user; a data collection component configured to: receive data from one or more sensors in a non-clinical environment over time; and track an activity level of the user over time based upon the data from the one or more sensors in the non-clinical environment, the activity level being indicative of at least one of the symptom of the user desirably managed by the medication or a side effect of the user resulting from the medication; a dosage determination component configured to determine the recommended dosages of the medication based upon static data of the user and the activity level of the user over time; and an output component configured to output information indicative of the recommended dosages of the medication.

### Example 14

The computing system according to Example 13, the data collection component configured to receive motion data of the user from a wearable sensor in the non-clinical environment over time, the activity level being tracked based upon the motion data of the user.

### Example 15

The computing system according to an of Examples 13-14, the data collection component further configured to infer whether the user performs an activity of daily living based upon the data from the one or more sensors in the non-clinical environment.

### Example 16

The computing system according to any of Examples 13-15 being a mobile consumer computing device in the non-clinical environment, wherein the one or more sensors comprises a sensor of the mobile consumer computing device.

### Example 17

The computing system according to any of Examples 13-16, wherein: the data collection component further configured to detect a number of occurrences of a physiological event of the user over time based upon the data from the one or more sensors in the non-clinical environment; and the dosage determination component further configured to determine the recommended dosages of the medication based upon the number of occurrences of the physiological event of the user detected over time.

### Example 18

A method of adjusting recommended dosages of a medication, comprising: identifying the medication, wherein the recommended dosages of the medication are desirably personalized by a mobile consumer computing device for a user to manage a symptom of the user; receiving data from one or more sensors in a non-clinical environment over time; detecting a number of occurrences of a physiological event of the user over time based upon the data from the one or more sensors in the non-clinical environment, the number of occurrences of the physiological event of the user being detected by the mobile consumer computing device, the number of occurrences of the physiological event of the user being indicative of at least one of the symptom of the user desirably managed by the medication or a side effect of the user resulting from the medication; determining the recommended dosages of the medication over time based upon static data of the user and the number of occurrences of the physiological event of the user detected over time, the recommended dosages of the medication being determined by the mobile consumer computing device; and outputting information indicative of the recommended dosages of the medication.

### Example 19

The method according to Example 18, wherein the physiological event comprises at least one of coughing, sneezing, vomiting, or tremors.

### Example 20

The method according to any of Examples 18-19, further comprising: tracking an activity level of the user over time based upon the data from the one or more sensors in the non-clinical environment; and determining the recommended dosages of the medication over time further based upon the activity level of the user over time.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of adjusting recommended dosages of a medication, comprising:
identifying the medication, wherein the recommended dosages of the medication are desirably personalized for a user;
receiving an indication of a symptom of the user desirably managed by the medication;
determining an initial recommended dosage of the medication based at least on static data of the user and the symptom of the user desirably managed by the medication;
collecting, from one or more sensors in a non-clinical environment, dynamic data indicative of efficacy of the medication for the user over time in the non-clinical environment, wherein the dynamic data indicative of the efficacy of the medication for the user over time in the non-clinical environment comprises:
data indicative of the symptom of the user desirably managed by the medication; and
data indicative of a side effect of the user resulting from the medication; and
refining a subsequent recommended dosage of the medication based on the static data of the user and the dynamic data indicative of the efficacy of the medication for the user over time in the non-clinical environment.

2. The method of claim 1, further comprising receiving the static data of the user from at least one of a personal health record service or a social network service.

3. The method of claim 1, wherein the static data of the user comprises information indicative of one or more of a known allergy of the user, a known response of the user to a differing medication in a class that includes the medication, previous medical history of the user, or previous emotional state history of the user for medications that have possible psychoactive side effects.

4. The method of claim 1, collecting the dynamic data indicative of the efficacy of the medication for the user further comprises:
receiving data from the one or more sensors in the non-clinical environment; and
detecting at least one of a quantity of sleep of the user or a quality of the sleep of the user based upon the data from the one or more sensors in the non-clinical environment;
wherein the subsequent recommended dosage of the medication is refined based upon the quantity of the sleep of the user or the quality of the sleep of the user.

5. The method of claim 1, collecting the dynamic data indicative of the efficacy of the medication for the user further comprises:
receiving data from the one or more sensors in the non-clinical environment; and
tracking an activity level of the user based upon the data from the one or more sensors in the non-clinical environment;
wherein the subsequent recommended dosage of the medication is refined based upon the activity level of the user.

6. The method of claim 1, collecting the dynamic data indicative of the efficacy of the medication for the user further comprises:
receiving data from the one or more sensors in the non-clinical environment; and
identifying at least one of a mood or a cognitive impairment of the user based upon the data from the one or more sensors in the non-clinical environment;
wherein the subsequent recommended dosage of the medication is refined based upon the mood or the cognitive impairment of the user.

7. The method of claim 1, further comprising:
receiving a cognitive state indicator for the user from a social network service; and
identifying at least one of a mood or a cognitive impairment of the user based upon the cognitive state indicator for the user;
wherein the subsequent recommended dosage of the medication is refined based upon the mood or the cognitive impairment of the user.

8. The method of claim 1, collecting the dynamic data indicative of the efficacy of the medication for the user further comprises:
receiving data from the one or more sensors in the non-clinical environment; and
detecting a number of occurrences of a physiological event of the user based upon the data from the one or more sensors in the non-clinical environment;
wherein the subsequent recommended dosage of the medication is refined based upon the number of occurrences of the physiological event of the user.

9. The method of claim 1, collecting the dynamic data indicative of the efficacy of the medication for the user further comprises:
receiving data from the one or more sensors in the non-clinical environment; and
tracking a physiological indicator of the user based upon the data from the one or more sensors in the non-clinical environment;
wherein the subsequent recommended dosage of the medication is refined based upon the physiological indicator of the user.

10. The method of claim 1, further comprising:
generating a survey for the user;
receiving feedback information from the user responsive to the survey; and
identifying the dynamic data indicative of the efficacy of the medication for the user based upon the feedback information responsive to the survey.

11. The method of claim 1 executed by a mobile consumer computing device in the non-clinical environment.

12. The method of claim 1, further comprising:
transmitting information indicative of the recommended dosages of the medication to a display device, the information indicative of the recommended dosages being presented upon a display screen of the display device.

13. A computing system, comprising:
a processor; and
a memory that comprises a dosage adjustment system that is executable by the processor, the dosage adjustment system comprising:
a medication identification component configured to identify a medication, wherein recommended dosages of the medication are desirably personalized for a user to manage a symptom of the user;
a data collection component configured to:
receive data from one or more sensors in a non-clinical environment over time; and
track an activity level of the user over time based upon the data from the one or more sensors in the non-clinical environment, the activity level being indicative of at least one of the symptom of the user desirably managed by the medication or a side effect of the user resulting from the medication;
a dosage determination component configured to determine the recommended dosages of the medication based upon static data of the user and the activity level of the user over time; and
an output component configured to output information indicative of the recommended dosages of the medication.

14. The computing system of claim 13, the data collection component configured to receive motion data of the user from a wearable sensor in the non-clinical environment over time, the activity level being tracked based upon the motion data of the user.

15. The computing system of claim 13, the data collection component further configured to infer whether the user performs an activity of daily living based upon the data from the one or more sensors in the non-clinical environment.

16. The computing system of claim 13 being a mobile consumer computing device in the non-clinical environment, wherein the one or more sensors comprises a sensor of the mobile consumer computing device.

17. The computing system of claim 13, wherein:
the data collection component further configured to detect a number of occurrences of a physiological event of the user over time based upon the data from the one or more sensors in the non-clinical environment; and
the dosage determination component further configured to determine the recommended dosages of the medication based upon the number of occurrences of the physiological event of the user detected over time.

18. A method of adjusting recommended dosages of a medication, comprising:
identifying the medication, wherein the recommended dosages of the medication are desirably personalized by a mobile consumer computing device for a user to manage a symptom of the user;
receiving data from one or more sensors in a non-clinical environment over time;
detecting a number of occurrences of a physiological event of the user over time based upon the data from the one or more sensors in the non-clinical environment, the number of occurrences of the physiological event of the user being detected by the mobile consumer computing device, the number of occurrences of the physiological event of the user being indicative of at least one of the symptom of the user desirably managed by the medication or a side effect of the user resulting from the medication;
determining the recommended dosages of the medication over time based upon static data of the user and the number of occurrences of the physiological event of the user detected over time, the recommended dosages of the medication being determined by the mobile consumer computing device; and
outputting information indicative of the recommended dosages of the medication.

19. The method of claim 18, wherein the physiological event comprises at least one of coughing, sneezing, vomiting, or tremors.

20. The method of claim 18, further comprising:
tracking an activity level of the user over time based upon the data from the one or more sensors in the non-clinical environment; and
determining the recommended dosages of the medication over time further based upon the activity level of the user over time.
